(19) United States
(12) Patent Application Publication
(10) Pub. No.: US 2006/0150730 A1
(43) Pub. Date: Jul. 13, 2006

(54) Device for determing at least one parameter of a medium flowing inside a conduit

(76) Inventors: Thomas Lenzing, Benningen (DE); Klaus Reymann, Gerlingen (DE); Uwe Konzelmann, Asperg (DE); Tobias Lang, Stuttgart (DE); Christoph Gmelin, Stuttgart (DE)

Correspondence Address: KENYON & KENYON LLP, ONE BROADWAY, NEW YORK, NY, 10004, US

(21) Appl. No.: 10/534,105

(22) PCT Filed: May 23, 2003
(86) PCT No.: PCT/DE03/01672

§ 371 Date: Oct. 6, 2005

(30) Foreign Application Priority Data
Nov. 20, 2002 (DE) 102 53 970.7

(51) Int. Cl. G01M 19/00

(52) U.S. Cl. 73/202.5; 73/118.2; 73/866.5

(57) ABSTRACT

A device for determining at least one parameter of a medium flowing in a line in a main flow direction includes a part adapted for introduction into the line. The part may include a measuring element for determining the at least one parameter; a measuring channel that may include an inlet, an outlet, a bent first section between the inlet and the measuring element, and a second section into which the first section may transition, the measuring element being located in the second section; and a projection, where a partial stream of the medium may flow in a measuring channel flow direction from the inlet to the outlet, the first section may redirect the partial stream after entering the measuring channel, and the projection may project into the measuring channel at a location downstream from the inlet and upstream from the measuring element relative to the measuring channel flow direction to direct the flow of the partial stream, and counteract a separation of the flow of the partial stream from channel walls of the measuring channel.

### FIELD OF THE INVENTION

The present invention relates to a device for determining at least one parameter of a medium flowing in a line.

### BACKGROUND INFORMATION

A device for determining the mass of a medium flowing in a line is described in published German patent document DE 101 35 142, the device including a part capable of being introduced into the line in which a measuring channel with a measuring element is located. Devices of this nature are used, for example, as air-mass meters in the air-intake manifold of an internal combustion engine. Splash water, dust, and oil vapor can enter the air-intake manifold and be transported by the medium to the part of the device that is inserted in the line. To prevent these contaminants from entering the measuring channel, the device includes an inlet region that discharges into a separation zone, and a measuring channel that branches off from the inlet region, so that the media stream that entered the inlet region divides, and a partial stream reaches the inlet of the measuring channel. As a result, contaminants are prevented from reaching the inlet of the measuring channel. The measuring channel includes a bent section downstream from its inlet, in which the partial stream of the medium that entered the measuring channel undergoes redirection. A disadvantage of this is that the stream may separate in the area of the bend and produce zones having a slower flow velocity, or even a backflow. Eddies and an irregularly pulsating flow occur in the region when there is no contiguous flow. Since the bent section transitions into a further section equipped with the measuring element, the separation of the flow upstream from the sensor element has an unfavorable effect on the flow conditions at the sensor element, which can result in increased signal noise in the sensor signal. The resultant change in the sensor signal may result in a disadvantageous deviation of the measured results from the values that are actually present.

### SUMMARY

In contrast, a separation of the flow in the region of the bent section of the measuring channel is prevented by the device according to the present invention for determining at least one parameter of a medium flowing in a line. This may be achieved via a projection that may project into the measuring channel, and that may be located downstream from the inlet and upstream from the measuring element, as viewed in the measuring channel flow direction. The projection may direct the flow and counteract a separation of the flow of the partial stream of medium from the channel walls of the measuring channel. The flow may be directed around the bend by the projection with little or no separation, which may improve the flow quality at the sensor element and reduce the signal noise.

In an example embodiment, the projection may include at least one single-component, continuous partition or at least one interrupted, double-component partition that may be located in the measuring channel transversely to the measuring channel flow direction. A plurality of partitions may also be situated behind each other or on top of each other in the measuring channel. The at least one partition may be capable of being introduced into the measuring channel without a greater amount of manufacturing outlay. If a double-component partition is used, the partition may include two partial wall sections that may project toward each other from diametrically opposed interior wall sections of the measuring channel and that may be separated by a gap. Longitudinal eddies may then occur at the ends of the partial wall sections that face each other, the axis of the longitudinal eddies extending in the measuring channel flow direction and the flow being stabilized.

In an example embodiment, to prevent a film of water on the wall formed by water droplets that entered the measuring channel from detaching from the partition and resulting in water droplets coming in direct contact with the sensor element, the back side—which faces away from the measuring channel flow—of the partition or the partial wall sections of the partition may be positioned at an angle relative to the measuring channel flow direction that is less than ninety degrees and greater than zero degrees. The inclination of the back wall may result in a cross-flow over the flow guide surfaces of the partition that extend parallel to the measuring channel flow, the cross-flow transporting water over the guide surfaces transversely to the measuring channel flow direction to the interior walls of the measuring channel, where the water may be able to collect without reaching the sensor element.

### BRIEF DESCRIPTION OF THE DRAWINGS

FIG. 1 shows a cross section through a part of a device that is provided with a measuring channel, in a position in which it is inserted in a line, according to an example embodiment of the present invention.

FIG. 2 shows an enlarged detailed view that shows a cross section perpendicular to the plane of the drawing in FIG. 1 through the measuring channel in the area of a partition, according to an example embodiment of the present invention.

### DETAILED DESCRIPTION

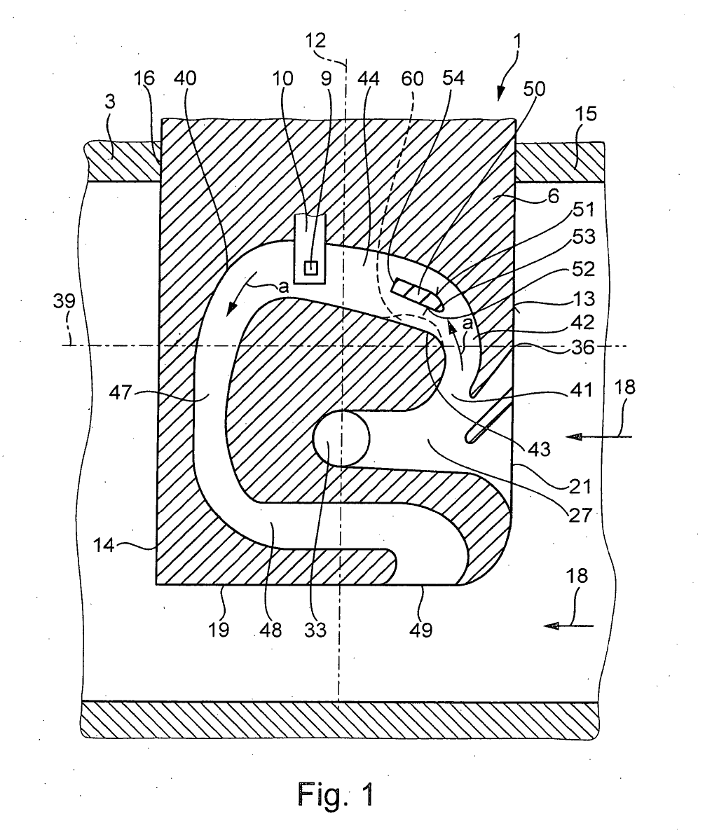

FIG. 1 shows a section of a line 3 through which a medium may flow in a main flow direction 18. The line may be an intake manifold of an internal combustion engine, for example. The medium may be, e.g., the air that is flowing in the intake manifold toward the internal combustion engine. A device 1 for determining a parameter of the medium flowing in line 3 may be positioned in line 3 in such a manner that a part 6 of this device may project into line 3 and may be exposed to the medium flowing there at a predetermined orientation. Device 1 for determining at least one parameter of the medium may include, in addition to part 6 introduced in the line, a carrier part (not shown) having an electrical connection, with evaluation electronics, for example, being housed in the carrier part. Device 1, with part 6, for example, may be inserted through an insertion opening 16 of a wall 15 of line 3, the wall 15 delineating a flow cross section of line 3. The evaluation electronics may be located within and/or outside of the flow cross section of line 3.

A measuring element 9 on a measuring element carrier 10 may be used in device 1, for example, the measuring element being electrically connected to the evaluation electronics. Using measuring element 9, the volumetric flow rate or the mass flow rate of the flowing medium, for example, may be determined as the parameter. Further parameters that may be measured are, for example, pressure, temperature, concentration of a medium constituent, or flow velocity, which may be capable of being determined using suitable sensor elements.

Device 1 may have, e.g., a longitudinal axis 12 in the axial direction, which extends, e.g., in the direction of installation of device 1 in line 3, and which may also be the center axis, for example. The direction of the medium flowing in the longitudinal direction of line 3, referred to herein below as main flow direction 18, is labeled in FIG. 1 with corresponding arrows 18, and extends there from right to left. When part 6 is installed in line 3, it may be ensured that part 6 has a predetermined orientation relative to main flow direction 18 of the medium.

Part 6 has a housing having a, e.g., rectangular structure having a front wall 13 that, in the installed position, may face main flow direction 18 of the medium, a back wall 14 facing away therefrom, a first side wall and a second side wall and a third wall 19 that may extend parallel to the main flow direction, for example. Part 6 may further include a channel structure located therein having an inlet region 27 and a measuring channel 40 that may branch off from inlet region 27. The positioning of device 1 relative to line 3 may ensure that the medium flowing in main flow direction 18 impacts part 6 in a predetermined direction, and a partial stream of the medium in this direction may travel through an opening 21 in front side 13 and may reach inlet region 27. Opening 21 may be oriented perpendicularly to main flow direction 18, for example, but another orientation of opening 21 relative to main flow direction 18 is also feasible. From inlet region 27 forward, a partial stream of the medium that entered the inlet region may pass through an inlet 41 into measuring channel 40 that may be equipped with measuring element 9 and that may branch off from the inlet region. A portion of the medium in the inlet region may continue to flow into a separation zone located downstream from the inlet of the measuring channel, this zone being connected to line 3 via at least one separation opening 33 located in the first side wall and/or the second side wall and/or wall 19.

Opening 21 in front side 13 of part 6 may include, in axial direction 12, a top edge 36 that may be closest to measuring element 9 in axial direction 12. An upper, imagined plane 39 extends through top edge 36 and perpendicular to the plane of the drawing in FIG. 1 and parallel to main flow direction 18. Separation opening 33 may be located, in axial direction 12, below this upper plane 39. Inlet region 27 may be provided, in the region of opening 21, with inclined or bent surfaces that may be configured such that the medium flowing into the inlet region may be directed away from upper plane 39. Liquid or solid-body particles that are contained in the partial stream of the medium that entered, and that are larger than and have a higher density than the gaseous flowing medium may move in axial direction 12 away from upper plane 39. Since separation opening 33 is located below upper plane 39, the liquid and solid-body particles may collect in a separation zone and may be suctioned out into line 3 by the air that flows past separation opening 33.

Starting at inlet region 27, a partial stream of the medium may pass through inlet 41 of measuring channel 40 and may reach a first, bent section 42 of the measuring channel. The partial stream of the medium that entered the measuring channel may flow through the measuring channel in measuring channel flow direction a from inlet 41 to outlet 48 of the measuring channel. For clarification, in the context of the present application, “measuring channel flow direction” refers to the direction of flow from the inlet to the outlet of the measuring channel, and not the velocity vectors of the individual flowing particles. The measuring channel flow direction therefore extends along the measuring channel and its bends to the outlet. The partial stream that traveled through inlet 41 into measuring channel 40 may be redirected in first, bent section 42 and, at the end of section 42, may reach a further section 44, that may extend nearly in a straight line and in which measuring element 9 may be located. At the inner radius of bent section 42, the flow may separate from interior wall 43 of the measuring channel if countermeasures are not provided. In FIG. 1, the separated flow is depicted by dashed line 60. Eddies and irregular pulsations may develop in the separated flow, which may have a disadvantageous effect on the flow in subsequent, further section 44 with measuring element 9.

To prevent the flow from separating in bent section 42, measuring channel 40 may therefore include a projection projecting into the measuring channel. The projection may direct the flow and counteract a separation of the flow from interior wall 43 of the measuring channel, e.g., preventing it entirely. The partial stream of the medium may then flow, without separating, into further section 44 of the measuring channel. In an example embodiment, the projection may include at least one single-component, continuous partition 50, which may be located transverse to measuring channel flow direction a in the transitional region from bent section 42 to further section 44. Partition 50 may be attached with two end sections facing away from each other and that are not shown in FIG. 1 to diametrically opposed wall sections of the interior wall of the measuring channel in such a manner that a line that connects the two end sections of the partition may extend nearly perpendicular to measuring channel flow direction a and, therefore, in FIG. 1, also perpendicular to the plane of the drawing. The partition may include a narrow front side 53 that may face measuring channel flow direction a, a back side 54 that may face away therefrom, and two flow guide surfaces 51 and 52 that may extend essentially parallel to the measuring channel flow direction. The partition may be rounded off at front side 53 and have a guide vane geometry or guide blade geometry.

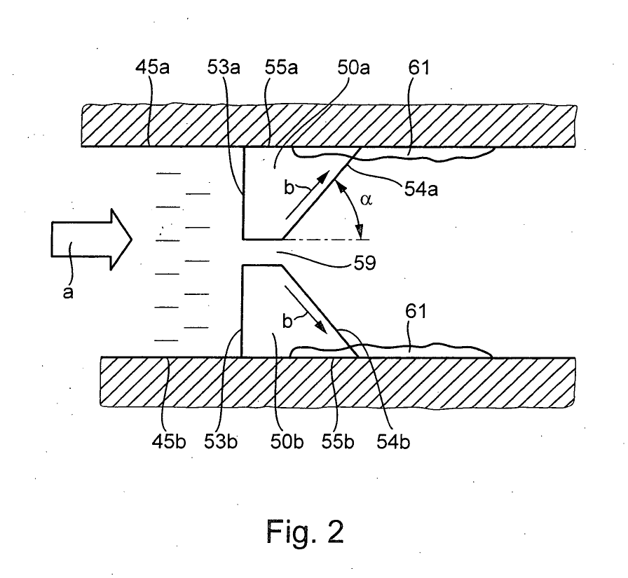

As shown in FIG. 2, in another example embodiment, partition 50 may also be configured as two components and include two partial wall sections 50a and 50b that may be attached with end sections 55a and 55b to diametrically opposed internal wall sections 45a, 45b of measuring channel 40 and may project toward each other. In one example embodiment, the two partial wall sections may be separated by a gap 59. In one example embodiment, front sides 53a and 53b of the partial wall sections may be oriented perpendicular to measuring channel flow direction a. In one example embodiment, back sides 54a and 54b of partial wall sections 50a, 50b may be flat and, as viewed in the cross section of FIG. 2, may form an angle with measuring channel flow direction a that is less than ninety degrees and greater than zero degrees, e.g., less than 70 degrees and greater than thirty degrees. If partition 50 has a single-component configuration as depicted in the example embodiment in FIG. 1, the single back wall may be oriented relative to the measuring channel flow direction at an angle that is less than ninety degrees and greater than zero degrees. The transverse position of back sides 54a, 54b in FIG. 2 may result in a transverse flow in the direction of arrow b over flow guide surfaces 51 and 52 extending parallel to measuring channel flow direction a. The transverse flow may transport water contained in the flow over the flow guide surfaces transverse to measuring channel flow direction a to interior walls 45a and 45b of the measuring channel, where water 61 may be able to collect without reaching sensor element 9.

Downstream from partition 50 in FIG. 1 or partial wall sections 50a and 50b in FIG. 2, the medium may flow into further section 44 toward measuring element 9. The cross section of further section 44 may taper in measuring channel flow direction a, which may be achieved via two acceleration ramps that face each other, whereby, in the depiction in FIG. 1, the observer is looking at a first ramp from a perpendicular perspective. As a result of the tapering of the cross section and/or the acceleration ramps in the form of a narrowing of the lateral surfaces of measuring channel 40 on all sides or partially, the medium may be transported rapidly through the measuring channel in measuring channel flow direction a and, as a result, may suctions air coming after it out of inlet region 27. From further section 44 forward, the medium may be redirected downstream from measuring element 9 into a channel section 47 that may extend away from insertion opening 16 approximately in axial direction 12. From this channel section forward, it may be redirected into a final channel section 48 that may extend, e.g., against main flow direction 18, and may pass through outlet 49 of measuring channel 40, which may be located, e.g., perpendicular to main flow direction 18 or at an angle to main flow direction 18, that is different from zero degrees, back into line 3.

1-11. (canceled)

12. A device for determining at least one parameter of a medium flowing in a line in a main flow direction, the device adapted for introduction into the line with a predetermined orientation relative to the main flow direction, comprising:
at least one measuring element configured to determine the at least one parameter of the medium;
at least one measuring channel including:
an inlet;
an outlet, wherein the at least one measuring channel is configured for a partial stream of the medium to flow in a measuring channel flow direction through the at least one measuring channel from the inlet to the outlet;
a bent first section located between the inlet and the at least one measuring element, and adapted for redirecting the partial stream after the partial stream enters the at least one measuring channel through the inlet; and
a second section, wherein the at least one measuring element is located in the second section, the first section transitioning into the second section in a transitional region; and
a projection that projects into the at least one measuring channel at a location downstream from the inlet and upstream from the at least one measuring element when viewed in the measuring channel flow direction, wherein the projection is adapted for directing the flow of the partial stream and for counteracting a separation of the flow of the partial stream from channel walls of the at least one measuring channel.

13. The device according to claim 12, wherein the projection includes a partition that is one of: a) at least one single-component, continuous partition located in the at least one measuring channel transversely to the measuring channel flow direction; and b) at least one interrupted, double-component partition located in the at least one measuring channel transversely to the measuring channel flow direction.

14. The device according to claim 12, wherein the projection is located in the transitional region from the first section to the second section.

15. The device according to claim 13, wherein the partition is attached with two end sections that face away from each other to diametrically opposed wall sections of an interior wall of the at least one measuring channel in such a manner that a line that connects the two end sections of the partition extends approximately perpendicularly to the measuring channel flow direction.

16. The device according to claim 13, wherein the partition includes end sections, a front side that faces the measuring channel flow direction, a back side that faces away from the measuring channel flow direction, and two flow guide surfaces extending approximately parallel to the measuring channel flow direction.

17. The device according to claim 16, wherein the front side is oriented perpendicularly to the measuring channel flow direction.

18. The device according to claim 16, wherein the back side extends, relative to the measuring channel flow direction, at an angle that is less than ninety degrees and greater than zero degree.

19. The device according to claim 13, wherein surfaces of the partition that are exposed to the flow of the partial stream have one of a guide vane geometry and a guide blade geometry.

20. The device according to claim 13, wherein the at least one interrupted, double-component partition includes two partial wall sections that project toward each other from diametrically opposed interior wall sections of the at least one measuring channel.

21. The device according to claim 20, wherein the partial wall sections are separated by a gap.

22. The device according to claim 20, wherein:
each of back sides of the partial wall sections extends, relative to the measuring channel flow direction, at an angle that is less than ninety degrees and greater than zero degree.

23. The device according to claim 22, wherein the angle is less than seventy degrees and greater than thirty degrees.

24. The device according to claim 12, wherein the medium is an intake air for an internal combustion engine, and the at least one parameter includes a mass of the intake air.
